(19) United States
(12) Patent Application Publication
(10) Pub. No.: US 2018/0236532 A1
(43) Pub. Date: Aug. 23, 2018

(54) THREE-DIMENSIONAL PRINTED TOOLING FOR HIGH PRESSURE DIE CAST TOOLING

(71) Applicant: FORD MOTOR COMPANY, Dearborn, MI (US)

(72) Inventors: Joy Hines FORSMARK, St. Clair Shores, MI (US); Jacob Wesley ZINDEL, Ann Arbor, MI (US); Harold P. SEARS, Livonia, MI (US); Larry Alan GODLEWSKI, Fenton, MI (US); John PHILLIPS, Ann Arbor, MI (US)

(21) Appl. No.: 15/435,726

(22) Filed: Feb. 17, 2017

(51) Int. Cl. B22D 17/22; B22C 9/06; B33Y 10/00; B33Y 70/00; B33Y 80/00; B23K 26/342; B23K 26/70; C21D 9/00; C21D 6/00; B22F 1/00; B22F 3/105

(52) U.S. Cl. CPC B22D 17/2209; B22C 9/061; B33Y 10/00; B33Y 70/00; B33Y 80/00; B23K 2203/04; B23K 26/70; C21D 9/0068; C21D 6/00; B22F 1/0003; B22F 3/1055; B23K 26/342

(57) ABSTRACT

A high pressure casting die is disclosed. The high pressure casting die may include a die half that defines a recessed area and a build plate that may nest within the recessed area of the die half. The high pressure die casting may further include an additive section that is disposed on the build plate. The additive section may include a plurality of metallic powder layers, the thermal conductivity or the thermal expansion coefficient of the build plate and the additive section may be within 10% of each other.

### TECHNICAL FIELD

The present disclosure relates to tooling for a high pressure die cast process and a method to make the same.

### BACKGROUND

Die casting is a metal casting process that forces molten metal under high pressure into a mold cavity. The mold cavity is typically comprised of multiple hardened tool-steel pieces that are machined into a predetermined shape to produce a desired part. The capital cost and the time associated with producing the tool-steel dies can be relatively expensive and time consuming making prototype parts nearly impossible to produce. In certain applications, a three-dimensional powder sintering process may be used to create the tool-dies in a quicker and more cost-efficient manner.

### SUMMARY

According to one embodiment of this disclosure, a high pressure casting die is disclosed. The high pressure casting die may include a die half that defines a recessed area and a build plate that may nest within the recessed area of the die half. The high pressure die casting may further include an additive section that is disposed on the build plate. The additive section may include a plurality of metallic powder layers, the thermal conductivity or the thermal expansion coefficient of the build plate and the additive section may be within 10% of each other.

The build plate may be a heat treated build plate having a hardness of at least 50 HRC.

The additive section may be a heat treated additive section having a hardness of at least 50 HRC.

The build plate and the casting surface may each have a thermal conductivity that is approximately equal to one another.

The build plate and the casting surface may each have a thermal conductivity that is approximately equal to one another.

The build plate and the casting surface may each have a thermal expansion coefficient that is approximately equal to one another.

The additive section may include a casting surface and the additive section may further define a plurality of cooling channels surrounding the casting surface. The plurality of cooling channels may facilitate conformal cooling of a cast component.

The casting surface may be configured to define a portion of a part extending above a base of the first die half.

According to another embodiment of this disclosure, a method of producing a high-pressure die casting die is provided. The method may include applying a plurality of powder layers to a build plate and melting at least a portion of each of the powder layers to form an additive section. The method may also include simultaneously heat treating the build plate and the additive section to mechanically couple the additive section to the build plate obtain a hardness of at least 50 HRC.

The method may also include machining the additive section to define a casting surface.

The additive section may further define a plurality of cooling channels surrounding the casting surface. The plurality of cooling channels may facilitate conformal cooling of a cast component.

The build plate and additive section may each define a thermal conductivity. The thermal conductivity of the build plate and additive section may be within 10% of each other.

The build plate and additive section may each define a thermal expansion coefficient. The thermal expansion coefficient of the build plate and additive section may be within 10% of each other.

The method may also include inserting the build plate and casting surface into an outer base ring of a die half.

The melting step may be accomplished by a direct metal laser melting process.

According to yet another embodiment of this disclosure, a method of producing a high-pressure die casting die is provided. The method may include applying a plurality of powder layers to the build plate and directing a laser beam to melt at least a portion of each of the powder layers to form an additive section. The method may also include machining the additive section to define a casting surface.

The method may include heat treating the build plate and casting surface to a provide at least a hardness level of 50 HRC.

The casting surface and the build plate may be mechanically joined by the heat treating step.

The machining step may remove excess flash defined by the additive section.

The build plate may be comprised of H-13 tool steel material and the plurality of powder layers may be comprised of maraging steel powder. In other embodiments the build plate and the plurality of powder layers may be comprised of other ferrous tool steels or ferrous steel powders.

### BRIEF DESCRIPTION OF THE DRAWINGS

FIG. 1 is a partial cross-sectional view of an example additive manufacturing process according to one embodiment of this disclosure.

FIG. 2 is a perspective view of the base plate and additive section assembly according to at least one embodiment of this disclosure.

FIG. 3 is a perspective view of the outer base ring according to at least one embodiment of this disclosure.

FIG. 4 is a perspective view of the die half assembly according to at least one embodiment of this disclosure.

FIG. 5 is a flowchart for a method according to one embodiment of this disclosure.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

Die casting is a manufacturing process for producing metal parts that often have complex shape and require dimensional accuracy that is often not achievable by metal stamping operations. High Pressure Die Casting (HPDC) involves injecting liquid metal (often aluminum) at a fast velocity under high pressure into reusable steel dies. Compared with other casting processes, the temperature and velocity of the casting material is very high; temperatures often exceed 700° C. and the fill time, time for the cavity to fill with liquid metal, is often near 40 milliseconds. This high results in a turbulent flow and contact between the molten metal and die surface.

A steel mold, sometimes referred to as a die, contains cavities that form castings, and includes two die halves to permit removal of the castings. Dies are typically capable of producing up to hundreds of thousand parts in rapid succession over the lifetime of the tool. A basic HPDC die includes a cover, which is stationary and is mounted securely in a die casting machine, and an ejector, which is moveable to release the cast part. More complex dies can contain additional slides that form complex surface features on the cast part.

Dies for HPDC typically require a large amount of capital and a long lead time. Because of the relatively high capital expense and the long lead time, dies for HPDC are not generally utilized for prototype components or in situations requiring running design changes, which often require a quick turnaround time. To overcome these disadvantages, the industry has turned to low volume casting processes such as, but not limited to, sand casting, plaster mold casting, shell molding, and investment casting. But these low volume casting processes come with their own disadvantages. A part produced by the low volume casting process may not be fully representative of a part produced by HPDC. The low volume casting processes may cool at a slower rate compared to HPDC and can result in the cast part having different material properties compared to a cast part produced by HPDC. Moreover, because of design constraints associated with the low volume casing processes mentioned above, parting lines often develop in locations different from those produced by HPDC.

One of the main contributors to varying material properties between a part produced by HPDC and a part produced by sand or plaster casting is the difference in thermal conductivity between a HPDC and a sand or plaster casting. Aluminum cools relatively faster in a metal die used in HPDC than in sand or plaster. Additionally, the fill time and the flow of the material vary greatly between a HPDC process and a sand casting process. The time required for a material to cool and subsequently solidify may impact the microstructure of the material. The microstructure, particularly grain size, orientation of the grain, presence and location of pores, may correlate to material properties, e.g., tensile strength, hardness, and etc.

Additive manufacturing also known as three-dimensional (3D) printing, is a process used to create a three-dimensional object applying successive layers of material to create an object. A digital model created through computer aided design (CAD) is typically used to control the process and create the object. The process starts by slicing the 3D CAD file data into layers, normally between 20 to 100 micrometers thick to create a 2D image of each layer. The Metal Powder Bed Melting process applies thin layers of atomized fine metal powder using a coating mechanism onto a substrate plate, usually metal, that is fastened to an indexing table and a piston that moves in the vertical (Z) axis. This takes place inside a chamber containing a tightly controlled atmosphere of inert gas, either argon or nitrogen at oxygen levels below 500 parts per million. Once each layer has been distributed, each 2D slice of the part geometry is fused by selectively melting the powder. This is accomplished with a high-power laser beam, usually an ytterbium fiber laser with hundreds of watts. The laser beam is directed in the X and Y directions with two high frequency scanning mirrors. The laser energy is intense enough to permit full melting (welding) of the particles to form solid metal. The process is repeated layer after layer until the part is complete.

Utilizing additive manufacturing in combination with standard or existing die halves provides a relatively quick and cost efficient method to create at least a portion of a HPDC die. A standard die half, that has been previously used or is intended for multiple uses can be utilized in combination with portion of the die produced by additive manufacturing.

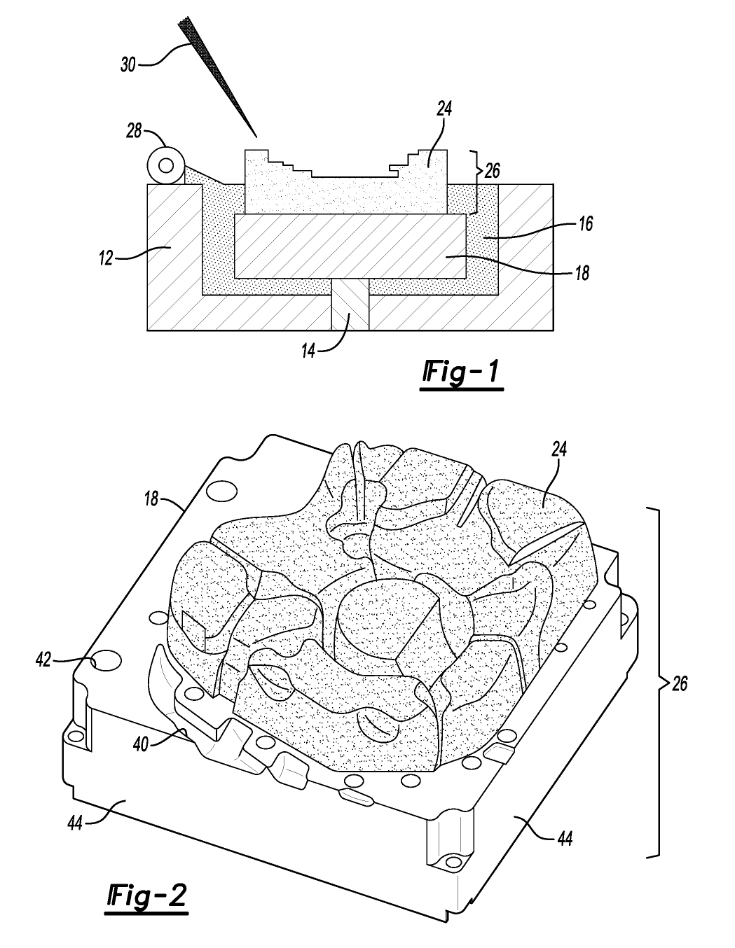

Referring to FIG. 1, an example production setup for producing a die half utilizing additive manufacturing is illustrated. A powder bed 12 includes and a build plate 18 positioned on top of a powder delivering piston 14. A steel powder 16 is disposed within the powder bed and surrounds the build plate 18 and the powder delivering piston 14. The steel powder 16 can be a maraging steel powder, though other steel powders or ferrous alloys may be utilized. Maraging steel is a group of steels that have high strength and high hardness and are not hardened by carbon. This type of steel can be heat treated to an appropriate hardness (e.g. Rockwell C>50). Rockwell C refers to a portion of the Rockwell scale, a hardness scale based on the indentation hardness of a material. The Rockwell test determines the hardness of a material by measuring the depth of penetration of an indenter under a relatively large load as compared to the penetration made by a preload. The various Rockwell scales, i.e., A scale, B, scale, C, scale, through G scale, each utilize a uniquely sized indenter and a unique load.

The heat treatment process may include a relatively simple heat treatment schedule that is conducted at a low enough temperature as to not affect the heat treatment of the existing tool steel in the existing die. In general, maraging steels have good stability at high temperatures and are suitable for die casting applications. The maraging steel may include one of or a range of the following percentages: 14%-22% nickel, 5.0%-15.15% cobalt, 0.5%-8.2% molybdenum, 0.10%-2.5% titanium, and 0.05%-0.25% aluminum by weight with the balance being iron. The maraging steel may have a thermal conductivity within the range of 20.5 W/m K to 30.5 W/m K. The thermal expansion coefficient may be between 6.8×10⁻⁶ and 17.3×10⁻⁶ inches.

The build plate 18 may be comprised of H-13 tool steel, however other suitable materials may be utilized. The steel of the build plate may include one of or a range of the following percentage of 0.32%-0.48% carbon, 0.32%-0.48% manganese, 0.8%-1.2% silicon, 4.2%-6.3% chromium, 1.08%-1.62% molybdenum, 0.8%-1.20% vanadium, by weight with the balance being iron. The steel may have a thermal conductivity within the range of 16.5 W/m K to 28.5 W/m K. The thermal expansion coefficient may be between 5.0×10⁻⁶ and 12.5×10⁻⁶ inches.

A high intensity energy beam 30 fully melts the powder in designated areas to create a layer of the additive manufactured portion 24 of the die. The high intensity energy beam, also referred to as a laser 30, applies sufficient power to locally melt the powder to fuse together the material and form a solid cross-section. The build plate 18 and powder delivering piston is then lowered and a roller or recoater 28 rolls over the next layer of the steel powder 16 to a predetermined thickness, generally between the range of 30-150 μm.

Referring to FIG. 2, an assembly 26 of the base plate 18 and additive section 24 produced by a process shown in FIG. 1, is illustrated. A cooling channel 40 partially surrounds the additive section and is disposed in the base plate 18. The cooling channel 40 may be machined by a CNC process or other suitable method. The cooling channel 40 may also be formed by the additive manufacturing process, therefore the channel 40 is integral to the additive section 24. The cooling channel 40 allows for conformal cooling of the cast component during the casting process. Traditional machining processes can only produce straight line cooling channels. However, utilization of an additive manufacturing process to produce cooling passages within the die can allow for a more complex shape, enabling cooling of specific areas of the die that may overheat in relation to other areas during casting production. This overheating can result in slower solidification of the part in those areas over the course of a casting run, which can increase cycle time or result in die sticking or local tearing of the part upon ejection. A number of holes 42 may be drilled or formed in the base plate. The holes 42 may be positioned under or around the additive section 24 is formed. In some holes, an ejector pin may move through it to separate the die halves after casting. Or the holes 42 may be threaded and provide a means for attaching the base plate to the die half by a threaded fastener.

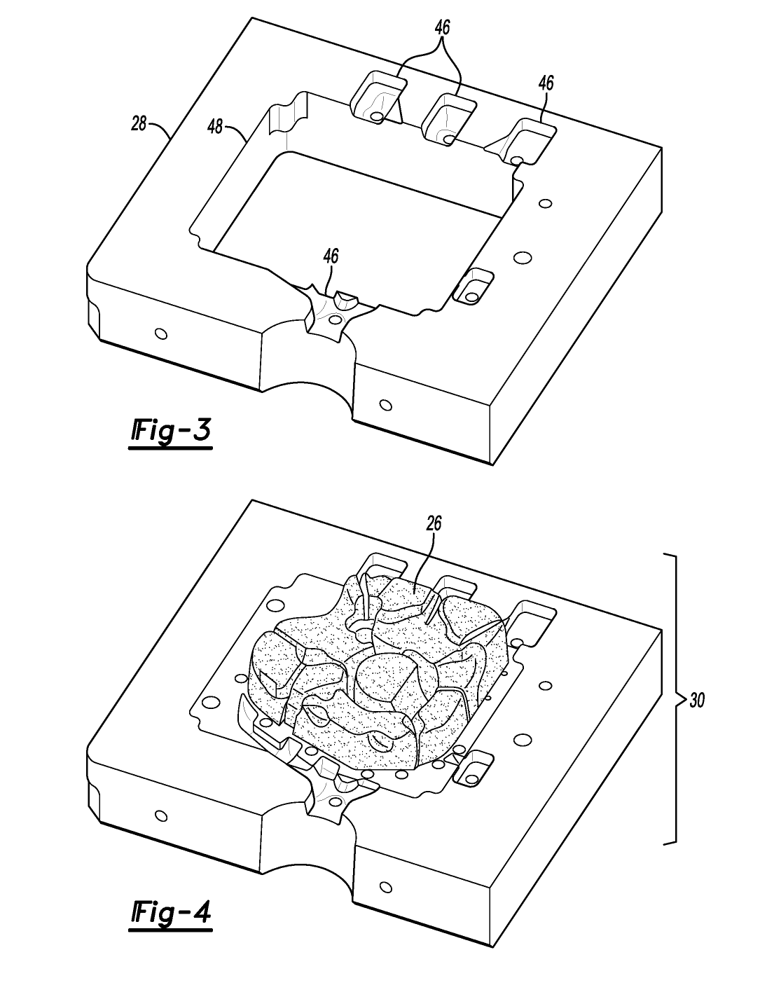

The base plate 18 includes an outer periphery 44 that is sized to fit in an outer base ring 28 (FIG. 3). The base plate 18 is can be made of a material that has high hardenability and excellent toughness. One non-limiting example is hardened H-13 tool steel, which is typical for applications involving aluminum base dies, aluminum casting and extrusion dies, zinc die casting dies, and so on. H-13 tool steel has good thermal conductivity and high hardness, making it suitable for high volume production. The base plate may be pre-heated to approximately 200° C. before placing the build plate into the powder bed 12. Heating of the build plate before creating the additive section increases the thermal conductivity of the H-13 tool steel build plate so that it is similar to or higher than the thermal conductivity of the maraging steel powder. This reduces residual stress between the build plate and additive section. Moreover, pre-heating the build plate may result in a higher weld quality between the powder and the build plate 18. After the assembly 26 is removed from the additive manufacturing process shown in FIG. 1, it is heat-treated and machine finished to its final size and shape. The heat treatment process increases the hardness of the assembly 26 and mechanically bonds the base plate 18 and the additive section 24 to one another. After heat treatment the hardness of the assembly may be between 50 and 55 Rockwell Hardness measured on the C scale (HRC).

Referring to FIGS. 3 and 4, an outer base ring 28 includes an aperture 48 that receives the assembly 26 discussed above and a die half are illustrated. The outer base ring 28 includes a number of overflow channels or wells 46 that may provide an additional space for molten metal to flow during solidification. The outer base ring 28, is may be modular. Meaning an existing base ring may be used to form the die half as opposed to a newly machined outer base ring 28. Referring specifically to FIG. 4, the die half 30 is shown. After placing the assembly 26 into the outer base ring 28, the die half 30 is provided. The die half is then placed within a high pressure die casting machine.

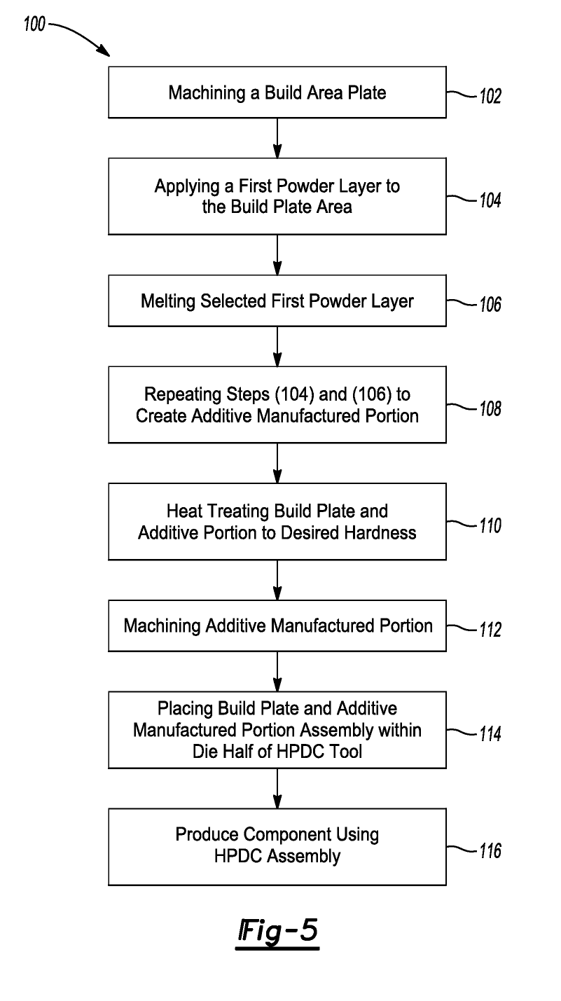

Referring to FIG. 5, a process 100 according to at least one embodiment of this disclosure is illustrated. The process begins at step 102 by machining or producing the build area plate 18. As mentioned above, the build plate is may be sized to fit within the outer base ring 28. At step 104 a first metallic powder 16 is applied to the build plate 18. The first powder layer 16 is then melted in select areas in step 106. Steps 104 and 106 are then repeated in step 108 until the additive manufactured section has been produced. The additive manufactured section 24 of the die and the build plate 18 are then heat treated to 490° C. for 6 hours but other suitable heat treatment methods may be utilized. The heat treating step may harden the additive section 24 and the build plate to a hardness of at least 50 HRC. After heat treatment in step 110, the part is then finish machined to provide the desired shape and size of the casting die. In step 112, the additive manufactured portion, joined with the base plate are then placed into the outer base ring 28, where it is then placed within the HPDC machine.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A high pressure casting die comprising:
a die half defining a recessed area;
a build plate nested within the recessed area of the die half; and
an additive section disposed on the build plate and comprising a plurality of sintered metallic powder layers, the thermal conductivity or the thermal expansion coefficient of the build plate and the additive section are within 10% of each other.

2. The high pressure casting die of claim 1, wherein the build plate is a heat treated build plate having a hardness of at least 50 HRC.

3. The high pressure casting die of claim 2, wherein the additive section is a heat treated additive section having a hardness of at least 50 HRC.

4. The high pressure casting die of claim 1, wherein the build plate and the additive section each have a thermal conductivity that is approximately equal to one another.

5. The high pressure casting die of claim 1, wherein the build plate and the additive section each have a thermal expansion coefficient that is approximately equal to one another.

6. The high pressure casting die of claim 1, wherein the additive section includes a casting surface and the additive section further defines a plurality of cooling channels surrounding the casting surface wherein the plurality of cooling channels facilitates conformal cooling of a cast component.

7. The high pressure casting die of claim 6, wherein the casting surface is configured to define a portion of a part extending above a base of a first die half.

8. A method for producing a high-pressure die casting die comprising:
applying a plurality of powder layers to a build plate and melting at least a portion of each of the powder layers to form an additive section; and
simultaneously heat treating the build plate and the additive section to mechanically couple the additive section to the build plate obtain a hardness of at least 50 HRC.

9. The method of claim 8, further comprising machining the additive section to define a casting surface.

10. The method of claim 9, wherein the additive section further defines a plurality of cooling channels surrounding the casting surface wherein the plurality of cooling channels facilitates conformal cooling of a cast component.

11. The method of claim 8, wherein a thermal conductivity of the build plate and a thermal conductivity of the additive section are within 10% of each other.

12. The method of claim 8, wherein a thermal expansion coefficient of the additive section and a thermal expansion coefficient of the build plate are within 10% of each other.

13. The method of claim 8, further comprising preheating the build plate before the applying step to increase the thermal conductivity of the build plate prior to melting at least a portion of each of the powder layers to form the additive section.

14. The method of claim 8, wherein the melting step is accomplished by a direct metal laser melting process.

15. A method of making a die for high pressure die casting comprising:
applying a plurality of powder layers to a build plate and directing a laser beam to melt at least a portion of each of the powder layers to form an additive section; and
machining the additive section to define casting surface.

16. The method of claim 15, further comprising heat treating the build plate and casting surface to a provide at least a hardness level of 50 HRC.

17. The method of claim 16, wherein the additive section and the build plate are mechanically joined by the heat treating step.

18. The method of claim 17, further comprising preheating the build plate before the applying step to increase the thermal conductivity of the build plate prior to melting at least a portion of each of the powder layers to form the additive section.

19. The method of claim 15, wherein the machining step removes excess flash defined by the additive section.

20. The method of claim 15, wherein the plurality of powder layers are comprised of maraging steel powder.
